(19) United States
(12) Patent Application Publication
(10) Pub. No.: US 2007/0252920 A1
(43) Pub. Date: Nov. 1, 2007

(54) TV signals reception system

(75) Inventors: Chin-Wang Chen, Sinjhuang City (TW); Hsi-Hung Hsu, Sinjhuang City (TW)

Correspondence Address: TROXELL LAW OFFICE PLLC, SUITE 1404, 5205 LEESBURG PIKE, FALLS CHURCH, VA, 22041, US

(73) Assignee: YI SHIAN ELECTRO-OPTICAL CO., LTD.

(21) Appl. No.: 11/414,332

(22) Filed: May 1, 2006

(51) Int. Cl. H04N 5/63

(52) U.S. Cl. 348/839; 348/730

(57) ABSTRACT

A TV signals reception system includes tuning circuit, control circuit, monitor drive circuit, power supply unit, and connection unit; video signals being modulated as received by the tuning circuit, and transmitted to control circuit where signals are processed and transmitted to monitor drive circuit, further to be transmitted along with drive signals to the monitor to drive the monitor and display video signals.

### BACKGROUND OF THE INVENTION

(a) Field of the Invention

The present invention is related to a TV(television) signals reception system, and more particularly, to one that is portable, allows separate connection to a monitor, and easy assembly.

(b) Description of the Prior Art

Whereas digital video broadcasting provides top picture quality, audio quality and value added services derived from data broadcasting, TV broadcasting is gradually transformed from the conventional analog system into digital system. Other than those features provided by video broadcasting system as described in the preceding paragraph, conventional analog system is vulnerable to topological interference to result in poor signal reception at the viewer's end in terms of signal transmission quality. On the contrary, signals from the digital video broadcasting system may be transmitted through multiple broadcasting media including but not limited to cable, satellite, microwave, and ground. Furthermore, the spectrum can be more effectively utilized by the digital video broadcasting system for the viewer's end to enjoy better picture quality and more programs.

FIG. 1 is a schematic view showing a computer system based TV signals reception system of the prior art. The reception system contains a TV card installed in a computer host 1 and the TV card is connected to an antenna to receive and process TV broadcasting signals as required; and a PC(personal computer) monitor to output TV pictures coming from the TV card. However, in the prior art the TV card must be installed in the computer host to warrant comparatively higher initial user costs to view TV broadcasting. Furthermore, before enjoying TV shows the viewer has to wait up for a long term for the PC to start up.

FIG. 2 is a schematic view showing another type of TV signals reception system of the prior art, a set-top box. The reception system includes a set-top box 21 and a monitor 22. The set-top box includes a power supply as a self-power, a display panel to display channel received and working status, and a TV signals reception processor. The monitor 22 to output the TV signals received from the top-set box 21 includes a built-in or externally connected loudspeaker to output audio signals. However, the set-top box must operate on a power supply as the self-power and a display panel to display channel received and working status. Furthermore, the set-top box significantly increases the space while occupying an independent space since it is prevented from being disassembled and directly incorporated to a computer monitor, such as a liquid crystal screen.

### SUMMARY OF THE INVENTION

The primary purpose of the present invention is to provide a TV signals reception system that is portable, allows easy assembly and separate connection to a monitor as desired.

To achieve the purpose, the present invention includes tuning circuit, control circuit, monitor drive circuit, power source unit, and connection unit. The tuning circuit receives and modulates video signals and transmits those signals to the control circuit where those video signals are processed and transmitted to the monitor drive circuit where those video signals and drive signals are transmitted to the monitor to drive the monitor for displaying those video signals received by the TV signals reception system.

Another purpose of the present invention is to provide a TV signals reception system that can be driven by an external power. To achieve the purpose, a connection unit is adapted to transmit signals to the monitor and power from the power supply built in the monitor to the TV signals reception system.

### BRIEF DESCRIPTION OF THE DRAWINGS

FIG. 1 is a schematic view of a TV signals reception system of the prior art.

FIG. 2 is a schematic view of another type of a TV signals reception system of the prior art.

FIG. 3 is a schematic view showing a construction of a preferred embodiment of the present invention.

FIG. 4 is a perspective view of the preferred embodiment of the present invention.

FIG. 5 is an exploded view of the preferred embodiment of the present invention connected to a monitor.

FIGS. 6(a) and 6(b) are exploded view showing a construction of another preferred embodiment of the present invention connected to a monitor.

FIG. 7 is a schematic view showing a construction of another preferred embodiment of the present invention.

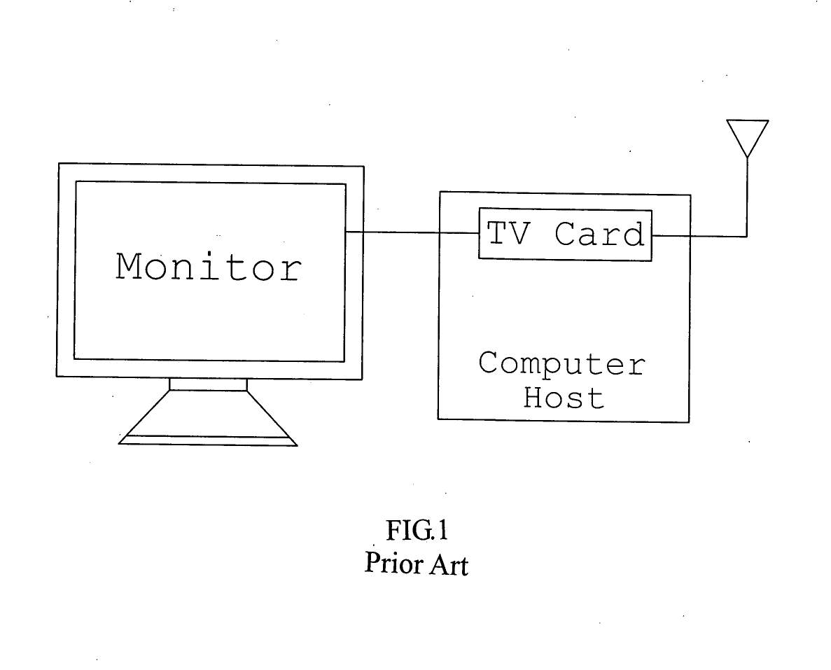

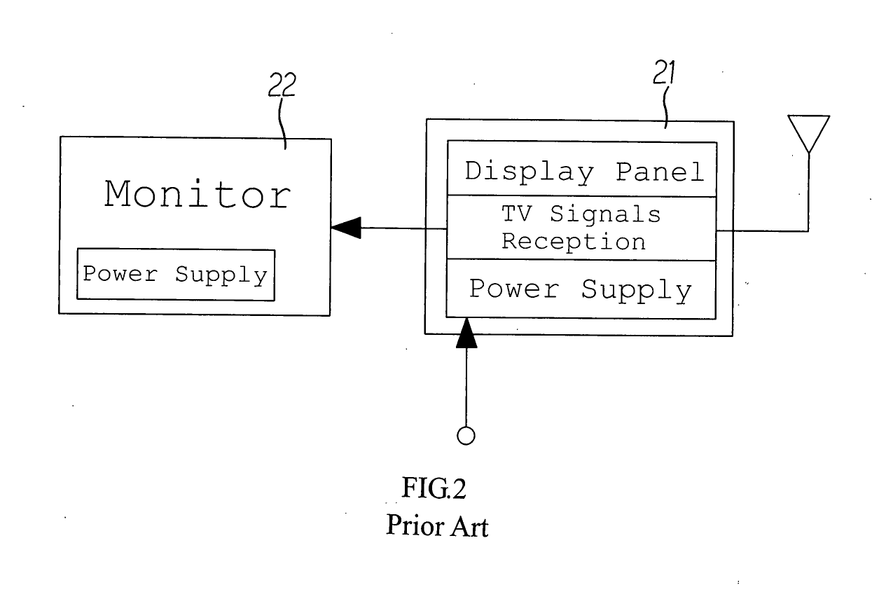

### DETAILED DESCRIPTION OF THE PREFERRED EMBODIMENTS

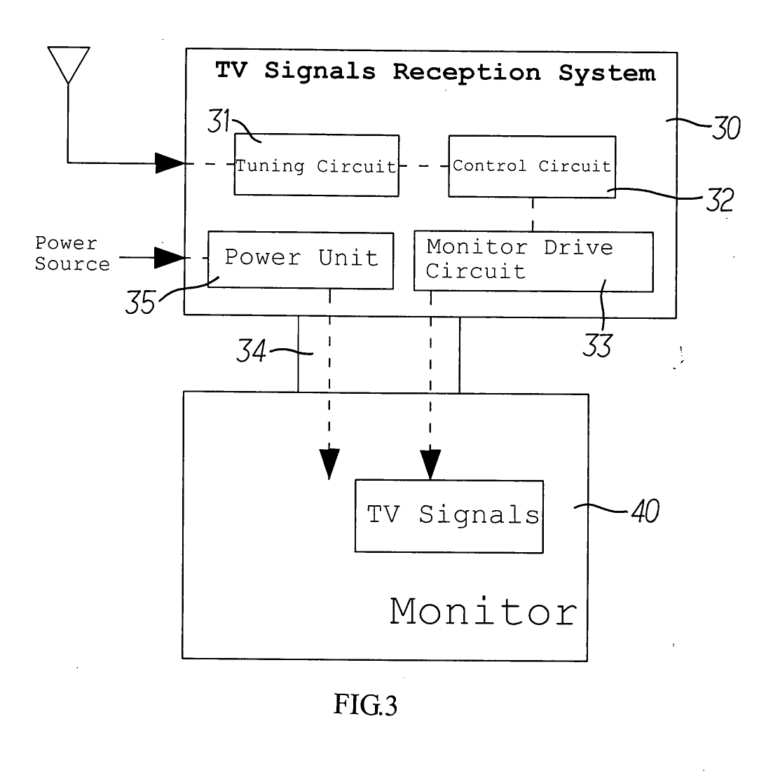

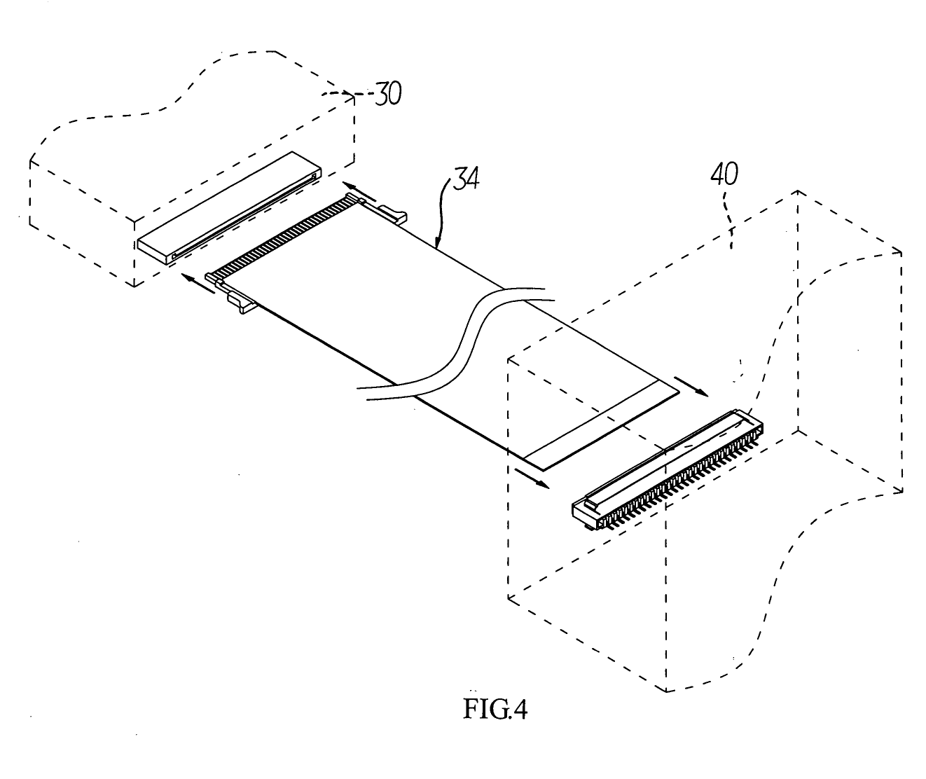

Referring to FIG. 3 for a TV signals reception system 30 of the present invention, the TV signals reception system 30 includes a tuning circuit 31, a control circuit 32, a monitor drive circuit 33, a connection unit 34, and a power unit 35. The tuning circuit 31 receives and modulates video signals and transmit the same to the control circuit 32; the control circuit 32 receives and processes modulated video signals before transmitting them to the monitor drive circuit 33; and the monitor drive circuit 33 receives the processed video signals and transmits via the connection unit 34 those video signals and drive signals to a monitor 40. The power unit 35 supplies internal power to the TV signals reception system 30. The connection unit 34 relates to a cabled transmission configuration may be provided in a form of a LVDS (Low Vol tage Differential Signaling) interface adapter to constitute connection between the TV signals reception system 30 and the monitor 40 as also illustrated in FIG. 4. Of course, the connection unit may be related to a wireless transmission configuration.

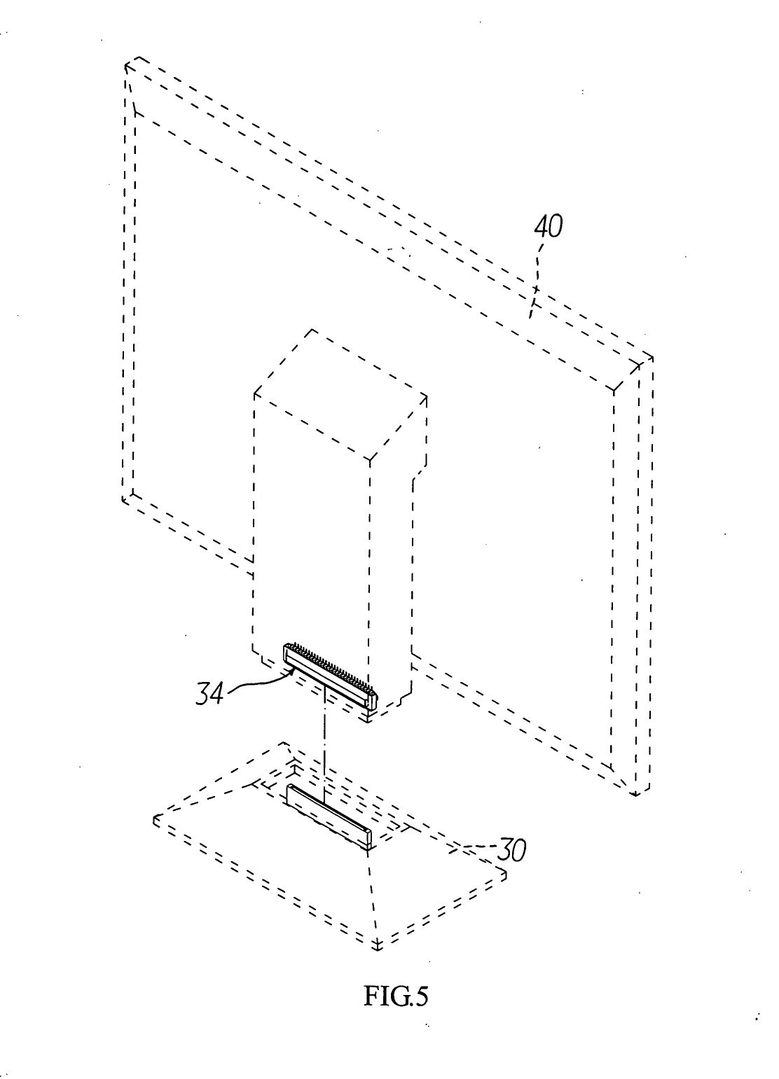

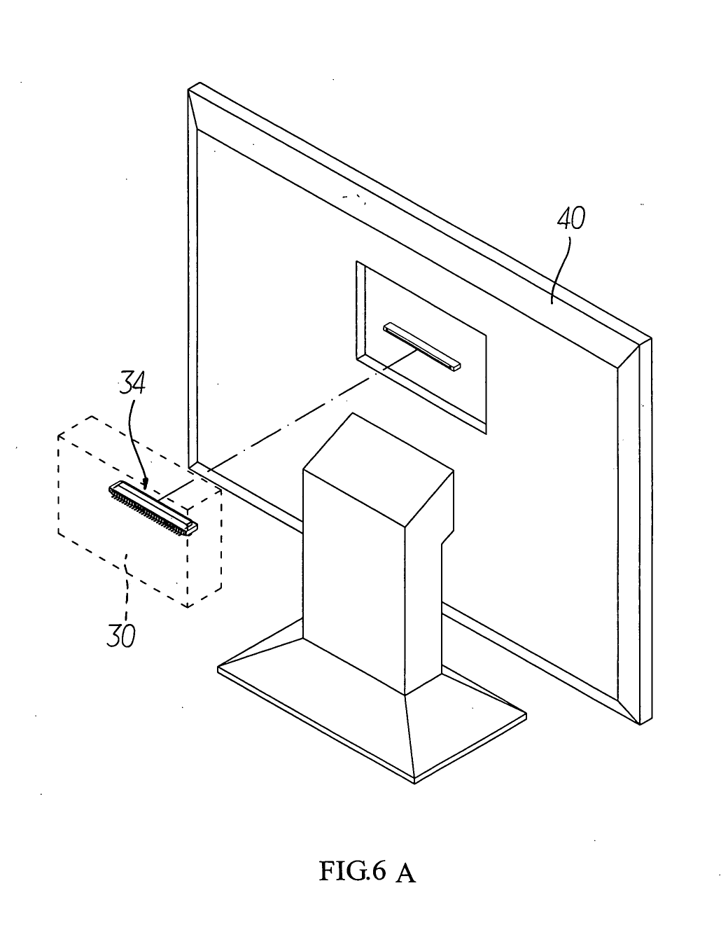

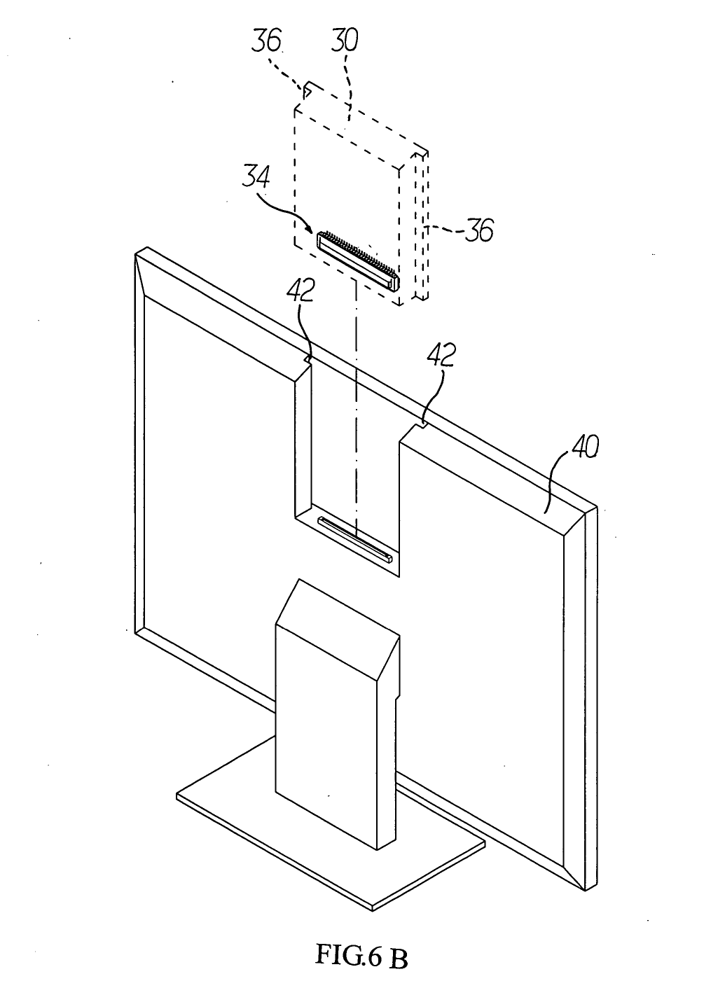

In practical use, the tuning circuit 31 receives and modulates video signals before transmitting them to the control circuit 32, where those signals are processed and transmitted further to the monitor drive circuit 33. By means of the connection unit 34, those video signals and drive signals are transmitted to the monitor 40 to drive the monitor 40 and display those video signals received by the TV signals reception system 30. Accordingly, the TV signals reception system 30 may be adapted to the monitor 40 by means of the connection unit 34 as desired to provide benefits of easy assembly and portability. The TV signals reception system 30 may be provided in the form of a base as illustrated in FIG. 5 to be mounted to the bottom of the monitor 40 and become an integral part of the monitor 40. Alternatively, the TV signals reception system 30 may be provided in the form of a rear lid as illustrated in FIGS. 6(a) and 6(b) to be mounted on the back of the monitor 40 and become an integral part of the monitor 40. As illustrated in FIG. 6(b), a channel 42 and a corresponding slide rail 36 are respectively provided at where between the back of the monitor 40 and the TV signals reception system 30 to hold the later in position on the back of the monitor 40.

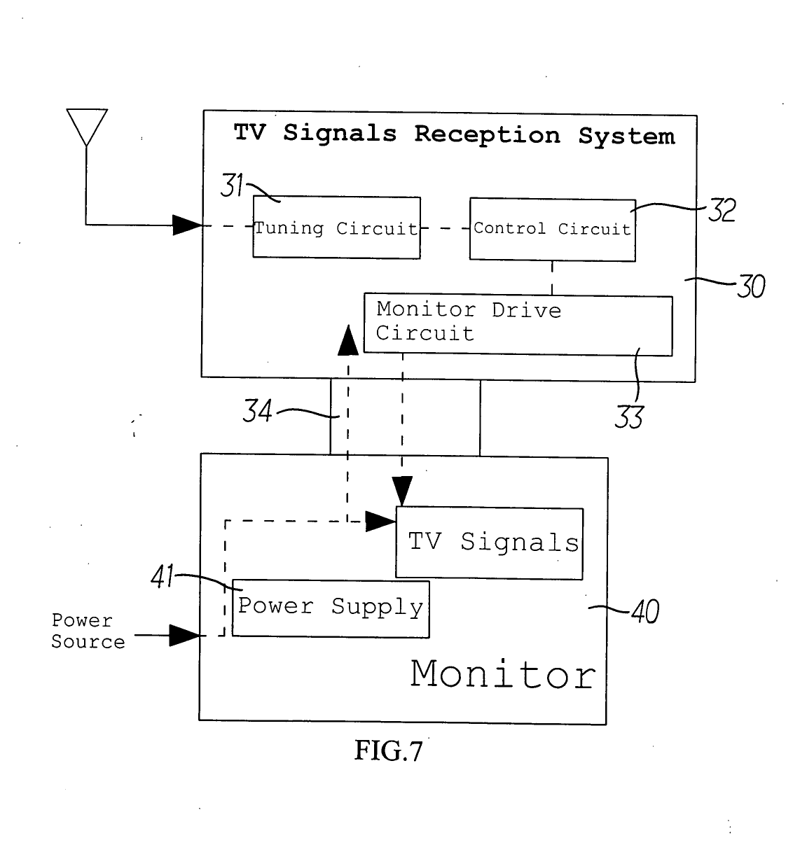

Now referring to FIG. 7 for a schematic view of another preferred embodiment of the present invention; wherein, no power unit is provided to the TV signals reception system. Instead, the connection unit 34 delivers the power supplied from a power supply 41 to be built in the monitor 40 to the TV signals reception system 30 for the power supply 41 to respectively supply internal power to the monitor 40 and external power to the TV signals reception system 30. Meanwhile, the TV signals reception system 30 contains the same tuning circuit 31, the control circuit 32, the monitor drive circuit 33, and the connection unit 34. By adapting the connection unit 34 to the monitor 40, video signals received from the tuning circuit 31 are processed and modulated for the connection unit to transmit them to the monitor where pictures corresponding to those video signals received by the TV signals reception system 30 are displayed.

The prevent invention provides an improved structure of a TV signals reception system, and the application for a utility patent is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. A TV signals reception system includes a tuning circuit, a control circuit, a monitor drive circuit, and a power unit; the tuning circuit receiving and modulating video signals before transmitting those signals to the control circuit; the control circuit receiving and processing the modulated video signals and transmitting them to the monitor drive circuit where processed video signals are received and transmitted together with drive signals to the monitor by means of a connection unit; and the power unit providing internal source to the TV signals reception system.

2. A TV signals reception system includes a tuning circuit, a control circuit, a monitor drive circuit, a connection unit, and a power supply; the tuning circuit receiving and modulating video signals before transmitting those signals to the control circuit; the control circuit receiving and processing the modulated video signals and transmitting them to the monitor drive circuit where processed video signals are received and transmitted together with drive signals to the monitor by means of a connection unit; the connection unit connecting the TV signals reception system and the monitor; and the power supply respectively supply internal power to the monitor and external power to the TV signals reception system.

3. A TV signals reception system of claim 1, wherein the connection unit related to a cabled transmission configuration.

4. A TV signals reception system of claim 2, wherein the connection unit related to a cabled transmission configuration.

5. A TV signals reception system of claim 1, wherein the connection unit is related to a cabled transmission configuration and the cabled transmission configuration is related to a LVDS interface adapter.

6. A TV signals reception system of claim 2, wherein the connection unit is related to a cabled transmission configuration and the cabled transmission configuration is related to a LVDS interface adapter.

7. A TV signals reception system of claim 1, wherein the connection unit is related to a wireless transmission configuration.

8. A TV signals reception system of claim 2, wherein the connection unit is related to a wireless transmission configuration.

9. A TV signals reception system of claim 1, wherein the reception system is made in the form of a base to be mounted on the bottom of the monitor.

10. A TV signals reception system of claim 2, wherein the reception system is made in the form of a base to be mounted on the bottom of the monitor.

11. A TV signals reception system of claim 1, wherein the reception system is made in the form of a rear lid to be mounted to the back of the monitor.

12. A TV signals reception system of claim 2, wherein the reception system is made in the form of a rear lid to be mounted to the back of the monitor.

13. A TV signals reception system of claim 1, wherein a channel and a corresponding slide rail are respectively disposed at where between the back of the monitor and the TV signals reception system to hold the latter in position to the back of the monitor.

14. A TV signals reception system of claim 2, wherein a channel and a corresponding slide rail are respectively disposed at where between the back of the monitor and the TV signals reception system to hold the latter in position to the back of the monitor.
